(19) United States
(12) Patent Application Publication
(10) Pub. No.: US 2010/0077404 A1
(43) Pub. Date: Mar. 25, 2010

(54) SYSTEM AND METHOD OF CONTROLLING SENSORY DEVICES

(76) Inventors: Hyun-Woo Oh, Daejeon (KR); Hae Ryong Lee, Daejeon (KR); Kwang Roh Park, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/488,640

(22) Filed: Jun. 22, 2009

(30) Foreign Application Priority Data
Sep. 25, 2008 (KR) 10-2008-0094062

(51) Int. Cl. G06F 9/44; G06F 9/54

(52) U.S. Cl. 719/313; 719/328

(57) ABSTRACT

A system for controlling a plurality of sensory devices includes a plurality of end devices having the plurality of sensory devices connected thereto, respectively, each end device generating an IR control signal to execute a sensory devices so as to present sensory effects; a multi-device controller for managing IR control codes as profiles, and issuing a device control command to control the sensory device on the basis of the sensory effect metadata; and a ZigBee coordinator for parsing the device control command from the multi-device controller, determining the sensory device to be controlled depending on the parsed control command and transmitting a control message corresponding to the parsed control command to the end device having the determined sensory device connected thereto through ZigBee communication.

### CROSS-REFERENCE(S) TO RELATED APPLICATION(S)

The present invention claims priority of Korean Patent Application No. 10-2008-0094062, filed on Sep. 25, 2008, which is incorporated herein by reference.

### FIELD OF THE INVENTION

The present invention relates to a single media multi-device (“SMMD”) technique for controlling a plurality of sensory devices, and more particularly, to a system and method for generating device control commands for a plurality of sensory devices sensory device on the basis of sensory effect metadata included in a single media and transmitting the device control command to the sensory devices to control thereof.

### BACKGROUND OF THE INVENTION

As well known in the art, devices representing sensory effects, such as bright light, wind, scent, and the like, at home or theater, may include, for example, curtains, vibration chairs, lights, issuing machines, air conditioners, electric fans, heaters, and the like and they are operated in accordance with internal interfaces or IR (Infra-Red) control codes. Of these, devices operating based on IR control codes are widely used. With respect to the IR control codes, a different control code is used for each sensory device and manufacturer. For this reason, it is required to have a structure capable of learning IR control codes of sensory devices to be controlled and manage the IR control codes, which are learned through such a learning function, as profiles.

In prior art techniques related to sensory effects, a ZigBee based control scheme has been proposed. In ZigBee based control scheme, Bluetooth communication is performed between a home server and a Z-URC (ZigBee Universal Remote Control). The Z-URC is an integrated ZigBee remote control, and communicates with a plurality of end devices that generate IR control codes. However, this scheme focuses on the technique of regenerating IR control signals in the end devices based on the ZigBee communication protocol, which is designed for connection of the end devices.

Another prior art includes a single remote controller in which an integrated protocol is predefined in a gateway supporting a plurality of communication interfaces and various devices. Therefore, multiple devices can be controlled by the single remote controller using the integrated protocol. However, this technique just proposes an integrated remote controller for a gateway that has various interfaces, such as RF, ZigBee, IR, and the like, and uses an integrated protocol in order to control the interfaces in an integrated manner.

Therefore, there is a need for a system that controls a plurality of sensory devices on the basis of sensory effect metadata included in a single media.

### SUMMARY OF THE INVENTION

It is a primary object of the present invention to provide a system and method that serves a user with sensory effects on the basis of sensory effect metadata included in a single media displayed at home or theater.

It is another object of the present invention to provide a system and method that transmits device control commands for controlling a plurality of sensory devices to end devices by ZigBee communication, such that each of the end devices can generate an internal interface command and an IR control signal so as to control a corresponding sensory effect device.

In accordance with a first aspect of the present invention, there is provided a multi-device controller for controlling a plurality of sensory devices based on sensory effect metadata included in a single media, including: an application control API (Application Programming Interface) for providing a device control command to control the sensory devices on the basis of the sensory effect metadata; a profile pool for storing IR control codes of the sensory devices as IR profiles; a profile manager for learning the IR control codes to construct the IR profiles to be stored in the profile pool; a control manager for acquiring an IR control code of a sensory device to be controlled through the profile manager and providing a control command of the acquired IR control code to the sensory device to be controlled; and a connection manager for managing the connection of the sensory devices, wherein the connection manager requests the profile manager to learn a new IR code system when there is a new sensory device having the new IR code system, and the profile manager stores an IR profile of the learned IR control code in the profile pool.

In accordance with a second aspect of the present invention, there is provided a ZigBee coordinator for controlling a plurality of sensory devices using a control command provided thereto, including: a parser for parsing the control command; a device determiner for determining a sensory device to be controlled in response to the parsed control command from the parser; a message manager for generating a control message to be transmitted to an end device having the sensory device connected thereto, wherein the message manager allocates an end point ID to the end device, which requests the binding, when receiving a Binding message from the end device and manages the Join message on the allocated end point ID therein through mapping when receiving a Join message from the end device having the allocated end point ID; an IR code fixer for instructing the IR control code to be generated from the end device when the end device is fixed; and a device mapmaker for fixing the IR control code in response to the instruction of the IR code fixer and for mapping an device ID of the end device, a control type and control method of the sensory device connected to the end device on an end point ID of the ZigBee coordinator.

In accordance with a third aspect of the present invention, there is provided an end device having a sensory device to be controlled by a control message, including: a parser for parsing the control message provided to the end device; a control type determiner for determining the control type of the sensory device, wherein the control type includes a ZigBee type and ZigBee-IR type; an IR code storage unit, if the end device is fixed, for downloading an IR control code of the sensory device to be fixed and storing the IR control code therein; a command manager for generation a control command depending on the control type determined by the control type determiner; an internal command generator for generating an internal interface command under the control of the command manager when the control type is the ZigBee type; an IR code generator for generating an IR control signal under the control of the command manager when the control type is the ZigBee-IR type; and a control transmitter transmitting the generated internal interface command and IR control signal to the sensory device.

In accordance with a fourth aspect of the present invention, there is provided a system for controlling a plurality of sensory devices based on sensory effect metadata included in a single media, including: a plurality of end devices having the plurality of sensory devices connected thereto, respectively, each end device generating an IR control signal to execute a sensory devices so as to present sensory effects; a multi-device controller for managing IR control codes as profiles, and issuing a device control command to control the sensory device on the basis of the sensory effect metadata; and a ZigBee coordinator for parsing the device control command from the multi-device controller, determining the sensory device to be controlled depending on the parsed control command and transmitting a control message corresponding to the parsed control command to the end device having the determined sensory device connected thereto through ZigBee communication.

In accordance with a fifth aspect of the present invention, there is provided a method for controlling a plurality of sensory devices, including: providing a device control command for representing sensory effect based on sensory effect metadata included in a single media to a multi-device controller; providing the device control command from the multi-device controller to a ZigBee coordinator; generating a ZigBee control message corresponding to the device control command to provide to an end device; and controlling the sensory device connected to the end device using a control signal corresponding to the ZigBee control message.

According to the present invention, the system for controlling a plurality of sensory devices generates a device control command on the basis of sensory effect metadata from a single media, and transmits the device control command to an end device through ZigBee communication. Each of the end devices generates an internal interface command and an IR control code so as to control a corresponding sensory device. Therefore, sensory devices operate in synchronization with the media, and thus a user who enjoys the media can view the media with realistic feeling.

With respect to IR control codes which differ from each sensory device and manufacturer, the IR control codes are managed through learning, an IR control code for a sensory device is found by search, and a ZigBee control message is generated on the basis of the searched IR control code. An end device extracts the IR control code from the ZigBee control message, and generates an IR control signal on the basis of the IR control code regeneration information. In this way, sensory devices that use different IR control codes can be controlled.

The ZigBee coordinator allocates end point IDs through binding, manages end point ID, device ID, control types, and control methods, selects a sensory device in accordance with a device control command, and finds a control type and a control method, thereby enabling accurate control. Therefore, an end device can conveniently provide information regarding what kind of device it is, what control type it has, and how to control it through the Join message.

When an end device controls a sensory device by an IR control code, the end device can be fixed. In fixing the IR control code, the IR control code is downloaded to an end device once and stored in the end device, and then a short control message is transmitted.

### BRIEF DESCRIPTION OF THE DRAWINGS

The above and other features of the present invention will become apparent from the following description of an embodiment given in conjunction with the accompanying drawings, in which:

FIG. 1 is a block diagram of a system for controlling a plurality of sensory devices according to an embodiment of the present invention;

FIG. 2 is a detailed block diagram of the multi-device controller shown in FIG. 1;

FIG. 3 is a detailed block diagram of the ZigBee coordinator shown in FIG. 1;

FIG. 4 is a detailed block diagram of the end device shown in FIG. 1;

FIG. 5 is a flowchart illustrating the operation of the multi-device controller shown in FIG. 2;

FIGS. 6A and 6B are a flowchart illustrating the operation of the ZigBee coordinator shown in FIG. 3;

FIGS. 7A and 7B are a flowchart illustrating the operation of the end device shown in FIG. 4; and

FIGS. 8A and 8B are a flowchart illustrating the overall operation of a sensory device control system according to an embodiment of the present invention.

### DETAILED DESCRIPTION OF THE EMBODIMENTS

Hereinafter, exemplary embodiments of the present invention will be described in detail with reference to the accompanying drawings.

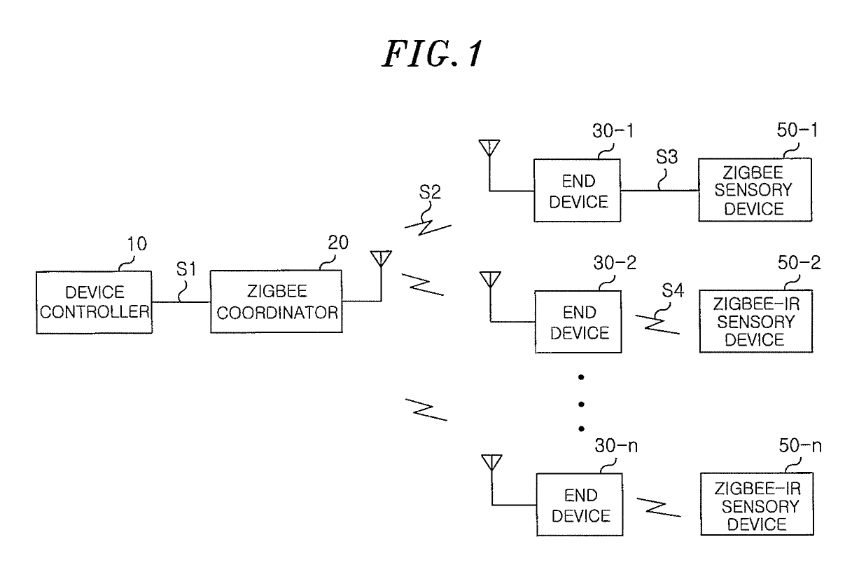

FIG. 1 is a block diagram of a system for controlling a plurality of sensory devices according to the present invention. The system controls a plurality of sensory devices on the basis of sensory effect metadata which is application software for sensory effect representation and included in a single media, thereby providing a user with sensory effects based on the single media.

As shown in FIG. 1, the system of the present invention includes a multi-device controller 10, a ZigBee coordinator 20, a plurality of sensory devices 50-1 to 50-n, and end devices 30-1 to 30-n individually generating IR control codes to drive the sensory devices 50-1 to 50-n so as to represent sensory effects.

The sensory devices 50-1 to 50-n include a ZigBee sensory device 50-1 connected to the end device 30-1 in a wired manner and ZigBee-IR sensory devices 50-2 to 50-n individually connected to the end devices 30-2 to 30-n in a wireless manner, e.g., ZigBee communication. Herein, a ZigBee sensory device denotes a ZigBee type device being controlled by a control single based on ZigBee protocol and a ZigBee-IR sensory device denotes a ZigBee-IR type device sensory device being controlled by an IR type control signal.

The multi-device controller 10 receives a device control command through the sensory effect metadata and analysis the control command to find out what IR control code controls a sensory device. Further, the multi-device controller 10 transmits the control command corresponding to the IR control code to the ZigBee coordinate 20 through an internal interface S1.

When power is supplied, the ZigBee coordinator 20 declares that it is a coordinator on a ZigBee network, performs data communication with the multi-device controller 10 through the internal interface S1, and performs message communication with the end devices 30-1 to 30-n through a ZigBee network S2. Further, the ZigBee coordinator 20 receives the control command from the multi-device controller 10, and determines what kind of ZigBee control message is to be transmitted to the sensory devices.

The end devices 30-1 to 30-n receive the device control message from the ZigBee coordinator 20 and produce an IR control code corresponding to the ZigBee control message for controlling the sensory devices 50-1 to 50-n. When being powered on and connected to the ZigBee network S2, each of the end devices 30-1 to 30-n requests the ZigBee coordinator 20 for binding and is then allocated with an end point ID from the ZigBee coordinator 20. Thereafter, each of the end devices 30-1 to and 30-n transmits a Join message including the allocated end point ID, a device ID, control type and control method thereof to the ZigBee coordinator 20.

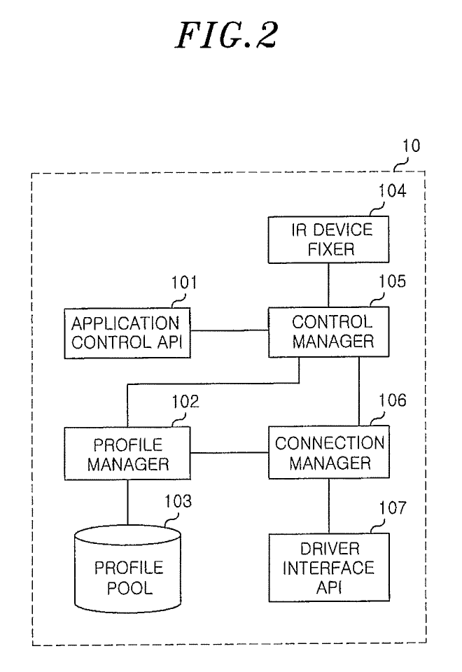

FIG. 2 is a detailed block diagram of the multi-device controller shown in FIG. 1. As shown in FIG. 2, the multi-device controller 10 includes an application control API (Application Programming Interface, hereinafter referred to as “API”) 101, a profile manager 102, a profile pool 103, an IR device fixer 104, a control manager 105, a connection manager 106 and a driver interface API 107.

The application control API 101 receives the device control command through the sensory effect metadata, and provides the control command to the control manager 105.

The profile manager 102 learns IR control codes, which differ from devices and manufacturers, by using an IR control code learner (not shown), and constructs IR profiles from the learned IR control codes. The IR profiles are stored in the profile pool 103. Further, the profile manager 102 searches the profile pool 103 for an IR control code in response to a request for the IR control code from the control manager 105 and provides the searched IR control code to the control manager 105.

The driver interface API 107 is connected to the ZigBee coordinator 20 through the internal interface S1 for the communication with the ZigBee coordinator 20.

The connection manager 106 acquires, from the driver interface API 107, a connection state regarding whether or not there is a sensory device connected to an end device. When receiving an inquiry of a connection state from the control manager 105, the deriver interface API 107 provides the connection state to the control manager 105. Further, when the connection manager 106 receives information regarding the connection of a new sensory device from the ZigBee coordinator 20 through the driver interface API 107, the connection manager 106 notifies the profile manager 102 that the sensory device having a new IR control code system is connected.

The control manager 105 inquires of the connection manager 106 whether or not there is a sensory device that is capable of executing the control command from the application control API 101. If it is determined that there is the sensory device, the control manager 105 requests the profile manager 102 to find an IR control code corresponding to the control command. In response to this request, the IR control code is transmitted from the profile manager 102 to the ZigBee coordinator 20 through the connection manager 106 and the driver interface API 107. However, if it is determined that no sensory device is connected, the control manager 105 notifies the application control API 101 that no sensory device is connected.

In case where a message indicative of the connection of the new sensory device is inputted from the connection manager 106, if an IR code system of the new sensory device exists in the profile pool 103, the component manager 106 manages the connection of the new sensory device. Meanwhile, when an IR code system of the new sensory device does not exist in the profile pool 103, the profile manager 102 requests the user to run the IR code learner so as to learn the IR control code of the new sensory device. In a scheme in which the respective end devices 30-1 to 30-n control the respective sensory devices in a one-to-one fashion, a ZigBee control message corresponding to an IR control code should be always transmitted from the ZigBee coordinator 20 to an end device. This scheme entails a load of the ZigBee communication. In order to reduce the load of the ZigBee communication, the control manager 105 may fix an IR control code to be generated by an end device. The operation to fix an IR device is executed by the IR device fixer 104. Accordingly, an IR control code to be generated by an end device is downloaded once, and even if the same device control command is inputted from the application control API 101 later, a short control command, not a control command for a full IR control code, is generated and then provided to the end device.

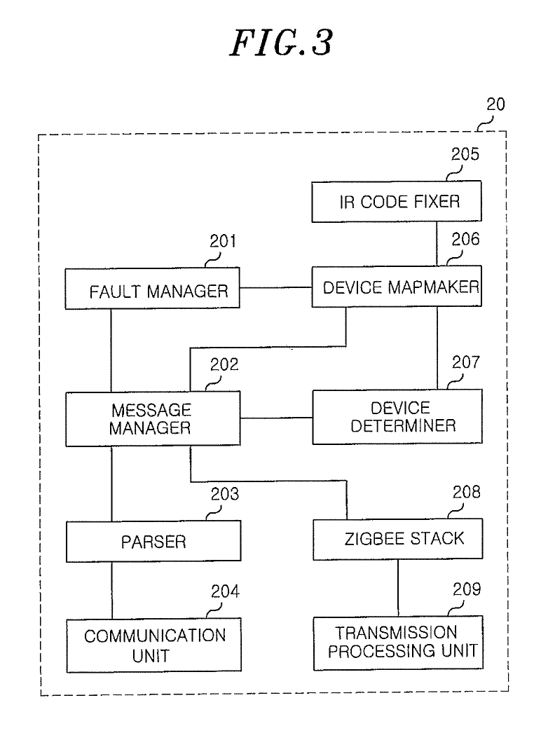

FIG. 3 is a detailed block diagram of the ZigBee coordinator shown in FIG. 1. As shown in FIG. 3 in detail, the ZigBee coordinator 20 includes a fault manager 201, a message manager 202, a parser 203, a communication unit 204, an IR code fixer 205, a device mapmaker 206, a device determiner 207, a ZigBee stack 208, and a transmission processing unit 209.

The fault manager 201 recognizes when a link at an application level is disconnected, and updates information of the device mapmaker 206.

The parser 203 parses messages received by the message manager 202 and provides the parsed message to the communication unit 204 for the communication with the multi-device controller 10. The parser 203 also receives messages from the multi-device controller 10 through the communication unit 204 and provides them to the message manager 203.

The communication unit 204 receives messages from the multi-device controller 10 through the internal interface S1 and provides them to the parser 203. The communication unit 204 also provides the parsed messages from the parser 203 to the multi-device controller 10 through the internal interface S1.

When the multi-device controller 10 sets such that any one of the end devices is fixed, the IR code fixer 205 instructs the device mapmaker 206 to fix an IR control code to be generated by the end device.

The device mapmaker 206 fixes the IR control code to be generated by the end device in accordance with the instruction from the IR code fixer 205. Further, the device mapmaker 206 maps information regarding the end device ID, the control type and control method on the allocated end point ID of the ZigBee coordinator 20.

The device determiner 207 determines a sensory device to be controlled in response to the parsed control message from the parser 203.

The ZigBee stack 208 temporarily stores messages from the message manager 202 and provides the temporarily stored messages to the transmission processing unit 209. The ZigBee stack 208 also temporarily stores messages from the transmission processing unit 209 and provides the temporarily stored message to the message manager 202.

The transmission processing unit 209 processes the messages between the ZigBee stack 208 for the ZigBee transmission of the message and the end devices 30-1 to 30-n through the ZigBee network S2.

The message manager 202 generates a ZigBee control message to be transmitted to the end device through the transmission processing unit 209, and receives messages from the end devices 30-1 to 30-n through the transmission processing unit 209.

If the message manager 202 receives a Binding message from any one of the end devices 30-1 to 30-n connected to the ZigBee network S2, the message manager 202 allocates one of end point IDs being managed therein to the end device that requests binding. If a Join message including the allocated end point ID, end device ID, control type and control method is received from the end device again with respect to the allocation, the message manager 202 manages the Join message by the device mapmaker 206 through mapping, and provides a connection message to the multi-device controller 10.

If a Keep Alive message is not cyclically received from each of the end devices 30-1 to 30-n, the message manager 202 recognizes that a fault occurs on the link at the application level, deletes the Binding message with respect to the end device, and releases the connection of the end device to the ZigBee network S2. If a Keep Alive message is received, the message manager 202 maintains the connection of the end device to the ZigBee network S2.

If a Sleep message is received from each of the end devices 30-1 to 30-n, the message manager 202 manages the connection state of the end device and maintains the connection. Meanwhile, if a control signal for controlling an end device having a sleep state is inputted from the multi-device controller 10, the message manager 202 transmits a Wake Up message so as to wake-up the end device in the sleep state, generates a ZigBee control message, and transmits the ZigBee control message to the end device.

If a Release message is received from each of the end devices 30-1 to 30-n, the message manager 202 deletes the Binding message to the end device, and releases the connection of the end device to the ZigBee network S2.

If the device control command is inputted from the multi-device controller 10, the message manager 202 determines what a sensory device is to be controlled through the device determiner 207, and confirms information regarding the device ID, the end point ID, control type and control method required to control the determined sensory device through the device mapmaker 206.

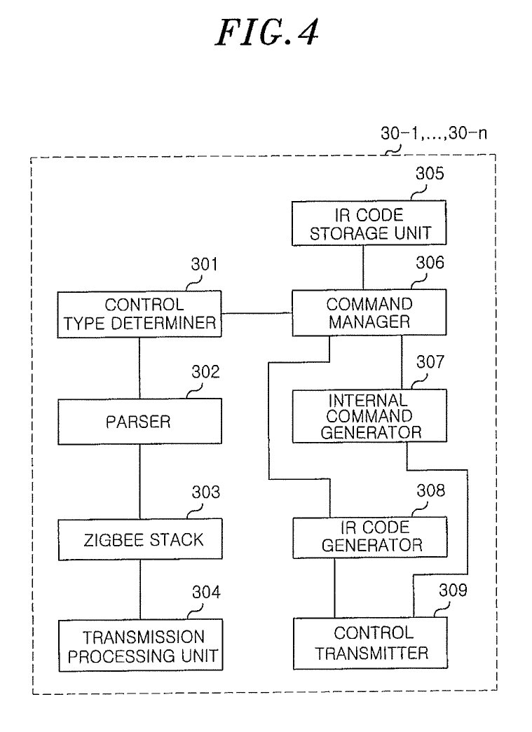

FIG. 4 is a detailed block diagram of the respective end devices shown in FIG. 1. As shown in FIG. 4, each of the end devices 30-1 to 30-n includes a control type determiner 301, a parser 302, a ZigBee stack 303, a transmission processing unit 304, an IR code storage unit 305, a command manager 306, an internal command generator 307, an IR code generator 308, and a control transmitter 309.

When the connection of each of the end devices 30-1 to 30-n should be released, a Release message is transmitted to the ZigBee coordinator 20 through the ZigBee network S2, and power is then turned-off. If the connection should not be released, a Keep Alive message is cyclically transmitted to the ZigBee coordinator 20 through the ZigBee network S2 so as to maintain the link at the application level. Each of the end devices 30-1 to 30-n is a small and low-power device and in most cases, operates with a battery. Accordingly, in terms of the lifespan of the battery, when there is no operation for a predetermined time, a Sleep message is transmitted from the end device to the ZigBee coordinator 20, and an operation mode of the end device is then switched to a sleep mode. If a Wake Up message is received from the ZigBee coordinator 20 under the sleep mode, the operation mode of the end device is switched to a normal mode.

The transmission processing unit 304 processes the message between the end device and the ZigBee coordinator 20 through the ZigBee network S2.

The ZigBee stack 303 temporarily stores the message from the parser 302 and provides the temporarily stored message to the transmission processing unit 304. The ZigBee stack 303 also temporarily stores messages from the transmission processing unit 304 and provides the temporarily stored messages to the parser 302.

The parser 302 parses a ZigBee control message from the ZigBee coordinator 20 and provides the parsed ZigBee control message to the control type determiner 301. The parser 302 also parses a Binding message from the control type determiner 301 and provides the parsed Binding message to the ZigBee stack 303.

The control type determiner 301 determines the control type of a sensory device to be actually controlled in accordance with the parsed message from the parser 302, and provides the control type to the command manager 306.

When a message provided from the parser 302 is the short control message, the control type determiner 301 analyzes the short control message and provides the analysis result to the command manager 306.

When the multi-device controller 10 sets such that an IR device is fixed, the IR code storage unit 305 downloads an IR control code from the ZigBee coordinator 20 and stores the IR control code in accordance with a message to fix the IR control code.

When the control type of the sensory device from the control type determiner 301 is the ZigBee sensory device, the command manager 306 controls the internal command generator 307 to generate an internal interface signal. The internal command generator 307 then generates the internal interface signal and provides the internal interface signal to the control transmitter 309 under the control of the command manager 306 in a wired manner.

Meanwhile, when the control type the sensory device is the ZigBee-IR sensory device, the command manager 306 controls the IR code generator 308 to generate an IR control code. The IR code generator 308 then generates the IR control code and provides the IR control code to the control transmitter 309 under the control of the command manager 306 in a wireless manner.

When a short control message is received from the ZigBee coordinator 20, the command manager 306 searches the IR code storage unit 305 for an IR control code for the sensory device executable the short control message, and then controls the IR code generator 308 to generate a corresponding IR control code.

The control transmitter 309 provides an internal interface signal from the internal command generator 307 to the ZigBee sensory device 50-1 through an internal interface S3. The control transmitter 309 also transmits the IR control code from the IR code generator 308 and to the ZigBee-IR sensory device through an IR network S4.

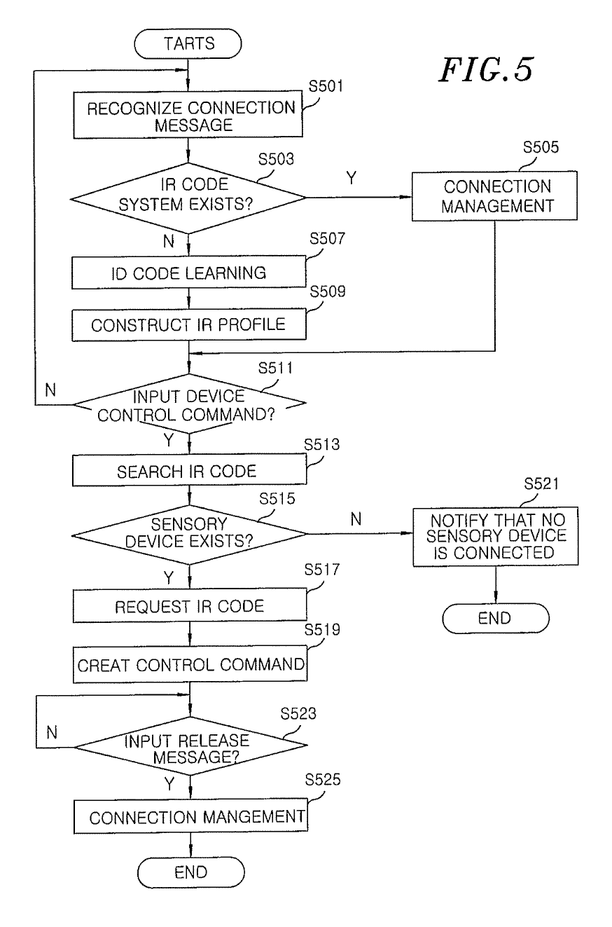

The operation of the multi-device controller 10 having the above-described configuration will be described in detail with reference to FIG. 5. FIG. 5 is a flowchart illustrating the operation of the multi-device controller 10 shown in FIG. 2.

First, IR control codes of the ZigBee-IR sensory devices 50-2 to 50-n are learned by an IR code learner online or offline, and the learned IR control codes are constructed as IR profiles by the profile manager 102 and stored in the profile pool 103.

The profile manager 102 receives a Connection message from the connection manager 106 and recognizes a connection of a new sensory device in step S501. The profile manager 102 then determines whether or not an IR code system of the new sensory device exists in the profile pool 103 in step S503.

If it is determined in step S503 that the IR code system exists, the profile manager 102 manages the connection of the new sensory device in step S505.

Meanwhile, if it is determined in step S503 that the IR code system of the new sensory device does not exist in the profile pool 103, the profile manager 102 requests the user to run the IR code learner so as to learn the IR code system of the new sensory device in step S507. The learned IR control code is constructed as an IR profile in step S509, and stored in the profile pool 103.

Next, if a device control command is inputted to the control manager 105 through the application control API 101 in step S511, the profile manager 102 searches the profile pool 103 for an IR control code corresponding to the device control command, and provides the searched IR control code to the control manager 105 in step S513.

Thereafter, the control manager 105 inquires of the connection manager 106 whether or not there is a sensory device, which is executable the device control command provided from the application control API 101, in step S515.

If it is determined in step S515 that there is a sensory device, the control manager 105 requests the profile manager 102 for an IR control code of the sensory device executable the device control command in step S517, receives the IR control code from the profile manager 102, and then generates a control command corresponding to the IR control code. The control command is provided to the ZigBee coordinator 20 through the connection manager 106 and the driver interface API 107, in step S519. Meanwhile, if it is determined in step S515 that there is no sensory device executable the device control command, the control manager 105 notifies the application control API 101 that there is no sensory device in step S521.

Next, if a Release message to release the connection of the end device to the internal interface S1 is received from the ZigBee coordinator 20 in step S523, the control manager 105 releases the connection of the end device to the internal interface S1 in step S525.

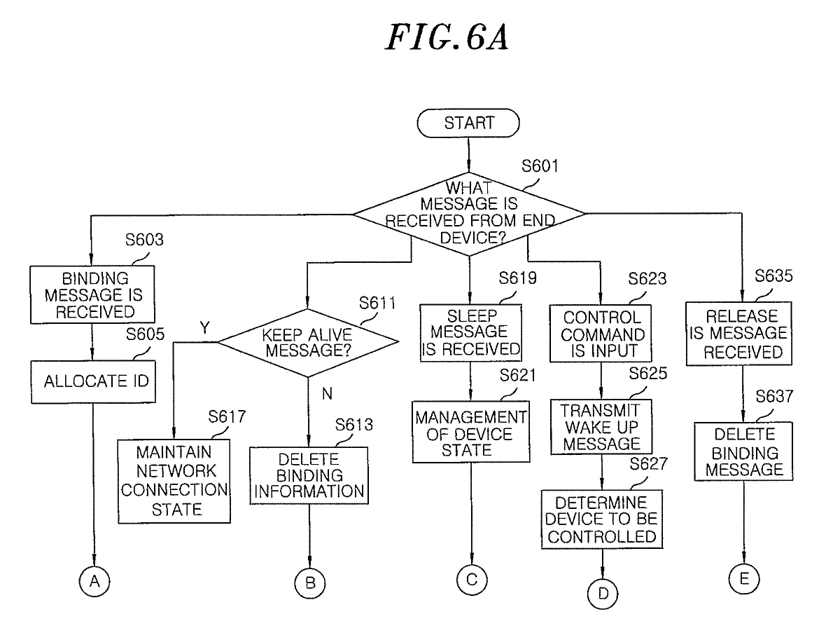

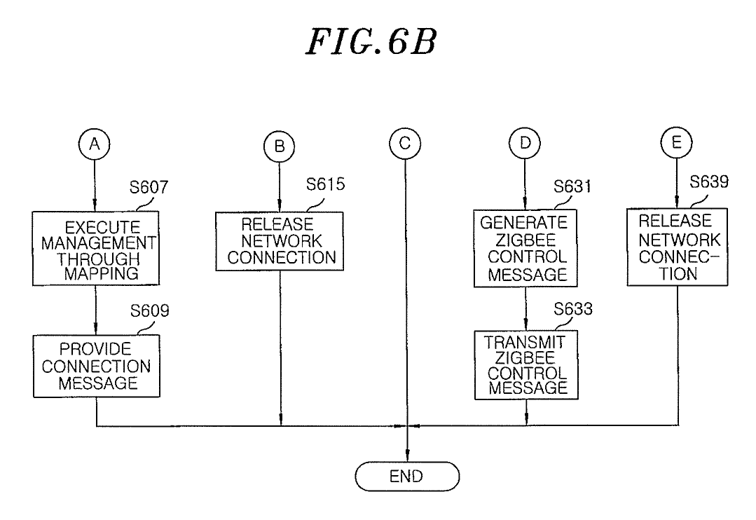

FIGS. 6A and 6B are a flowchart illustrating an operation of the ZigBee coordinator 20.

First, in step S601, the message manager 202 in the ZigBee coordinator 20 determines what message is received from the respective end devices 30-1 to 30-n via transmission processing unit 209.

As a result of determination in step S601, if a Binding message is received in step S603, the message manager 202 allocates an end point ID to an end device issuing the Binding message in step S605. If a Join message is received from the end device in response to the ID allocation, the message manager 202 manages the Join message by the device mapmaker 206 through mapping the Join message on the end point ID in step S607, provides a Connection message to the multi-device controller 10 through the communication unit 204 in step S609.

If it is determined in step S601 that a Keep Alive message is received, it is determined whether or not the Keep Alive message is received for a predetermined time in step S611. If it is determined in step S611 that the Keep Alive message is not received for the predetermined time, it is recognized that a fault occurs on the link at the application level, and information regarding the binding to the end device is deleted in step S613, and the connection to the internal interface S1 is released in step S615. However, if it is determined in step S611 that the Keep Alive message is received, the connection to the internal interface S1 is maintained in step S617.

As a result of determination in step S601, if a Sleep message is received in step S619, a device state of the end device is managed in step S621 and the connection is still maintained.

As a result of determination in step S601, if a control signal to control an end device being in a sleep state is received from the multi-device controller 10 in step S623, a Wake Up message is transmitted to wake the end device up in step S625, and what sensory device is to be controlled is determined by the device determiner 207 in step S627. Next, information regarding the end point ID, the short control command and the device ID of the end device required to control the determined sensory device is confirmed by the device mapmaker 206, and a ZigBee control message is generated in step S631 and transmitted to the end device in step S633.

As a result of determination in step S601, if a Release message is received in step S635, the Binding message is deleted in step S637 and the connection to the internal interface S1 is released in step S639.

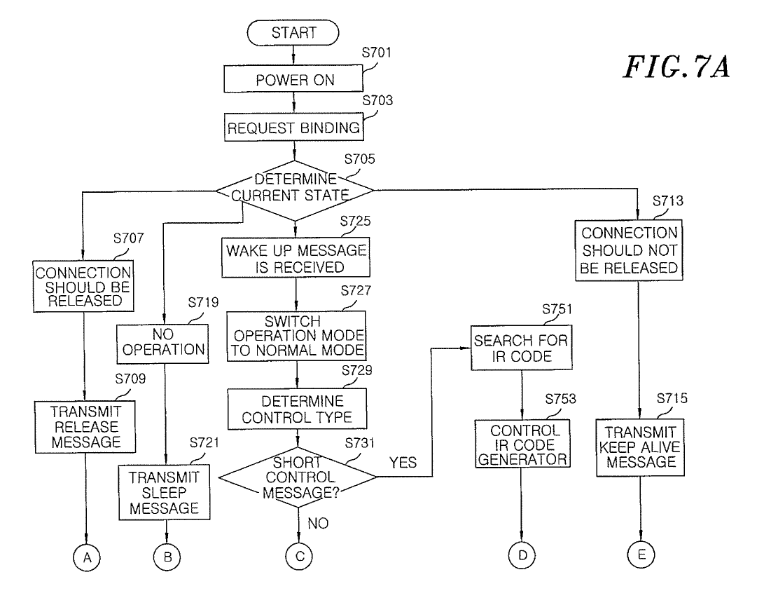

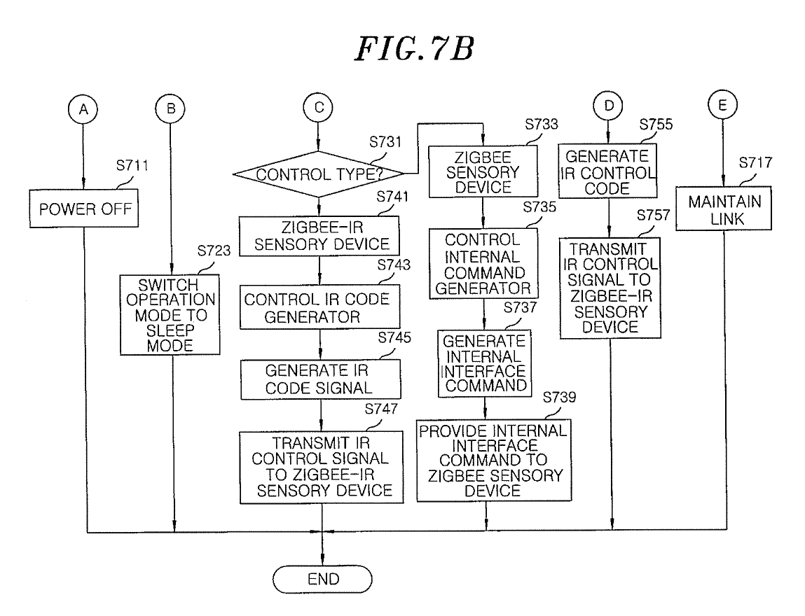

FIGS. 7A and 7B are a flowchart illustrating an operation of each of the end devices 30-1 to 30-n shown in FIG. 4.

When being powered on in step S701, each of the end devices 30-1 to 30-n requests a binding so as to be allocated with an end point ID from the ZigBee coordinator 20 in step S703.

Next, it is checked a current state for each of the end devices 30-1 to 30-n in step S705.

As a check result in step S705, if the connection should be released in step S707, a Release message is transmitted from the end device to the ZigBee coordinator 20 through the ZigBee network S2 in step S709, and power is off in step S711.

As a check result in step S705, if the connection should not be released in step S713, a Keep Alive message is cyclically transmitted from the end device to the ZigBee coordinator 20 through the ZigBee network S2 in step S715, thereby maintaining the link at the application level in step S717.

As a check result in step S705, if there is no operation in the end device for a predetermined time in step S719, the end device is regarded as being in the sleep state and a Sleep message is transmitted from the end device to the ZigBee coordinator 20 through the ZigBee network S2 in step S721. Then, the operation mode of the end device is switched into the sleep mode in step S723.

As a check result in step S705, if a Wake Up message is received from the ZigBee coordinator 20 through the ZigBee network S2 in the sleep mode of the end device in step S725, and the operation mode of the end device is switched into the normal mode in step S727.

After the end device is switched into the normal mode, the control type determiner 301 determines a control type of the sensory device to be actually controlled in accordance with a ZigBee control message from the parser 302 and provides the control type to the command manager 306 in step S729.

Thereafter, in step S731, it is determined if a short control message is inputted from the control type determiner 301. As a result of the determination, if positive, a control process goes to step S751, while if negative a control process advances to step S733.

In step 733, it the control type of the sensory device to be controlled is determined. As a result of the determination, if the control type is the ZigBee sensory device 50-1, the command manager 306 controls the internal command generator 307 to generate an internal interface command in step S735. The internal command generator 307 then generates the internal interface command depending on the control type in step S737, and relays the internal interface command to the control transmitter 309. Thereafter, the control transmitter 309 provides the internal interface command to the ZigBee sensory device 50-1 through the internal interface S3 in step S739.

If it is determined that the control type of the sensory device is the ZigBee-IR sensory device in step S741, the command manager 306 controls the IR code generator 308 to generate an IR control code in step S743. The IR code generator 308 then generates the IR control code depending on the control type of the ZigBee-IR sensory device in step S745, and provides the IR control code to the control transmitter 309. Thereafter, the control transmitter 309 transmits the IR control code to the ZigBee-IR sensory device through the IR network S4 in step S747.

Meanwhile, in step S749, the command manager 306 searches the IR code storage unit 305 for an IR control code corresponding to the short control message in step S751, and controls the IR code generator 308 to generate the IR control code in step S753. The IR code generator 308 then generates the IR control code corresponding to the short control message in step S755 and provides the generated IR control code to the control transmitter 309. After that, the Control transmitter 309 transmits the IR control code to the ZigBee-IR sensory device through the IR network S4 in step S757.

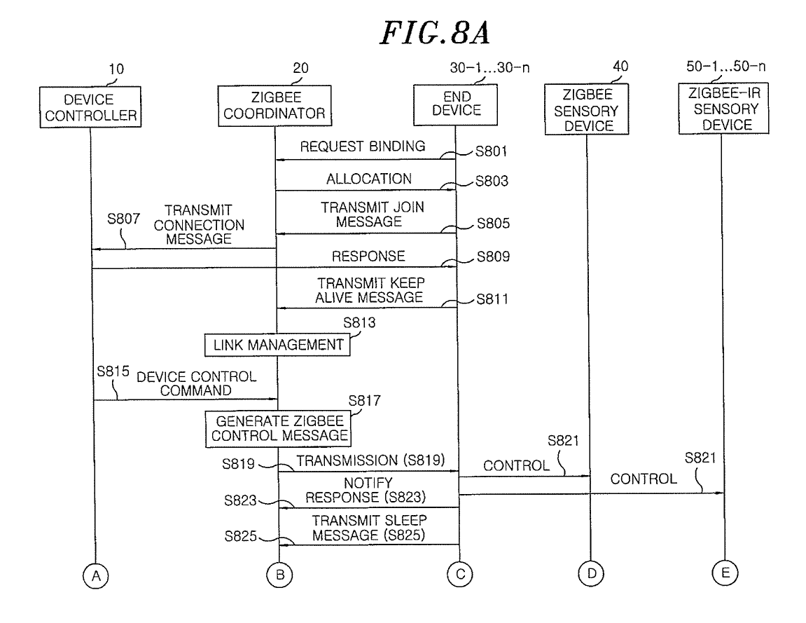

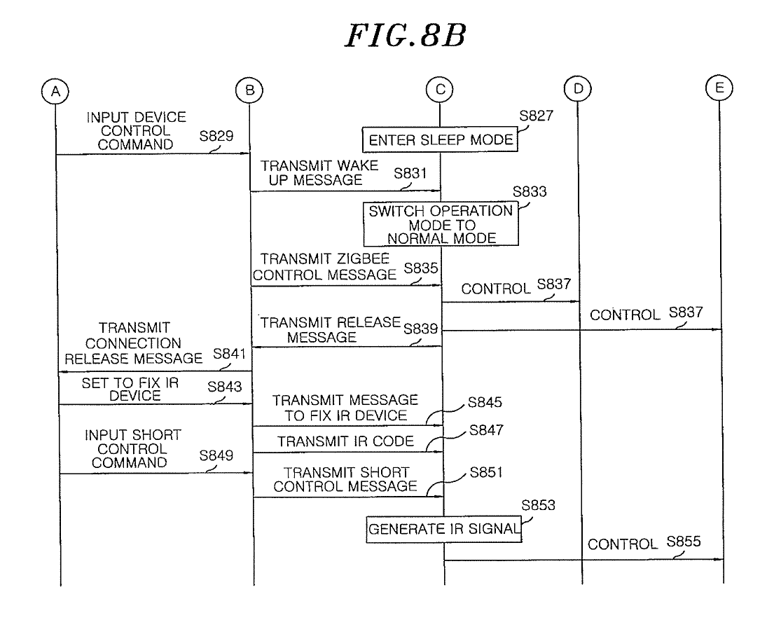

FIGS. 8A and 8B are a flowchart illustrating the overall operation of the system for controlling the sensory devices according to the present invention.

First, when an end device is connected to the ZigBee coordinator 20 through the ZigBee network S2, the end device requests the ZigBee coordinator 20 for binding in step S801.

The ZigBee coordinator 20 allocates an end point ID to the end device, which requests binding, in response to the binding request in step S803.

The end device, which requests binding, transmits a Join message including the allocated end point ID, the device ID and the control type to the ZigBee coordinator 20 in step S805.

The ZigBee coordinator 20, in response to the Join message, transmits a Connection message to the multi-device controller 10 through the internal interface S1 in step S807.

The multi-device controller 10 confirms the connection of the end device and responds to the end device through the ZigBee coordinator 20 in step S809.

Next, the end device cyclically transmits a Keep Alive message to the ZigBee coordinator 20 in step S811, and the ZigBee coordinator 20 manages the link at the application level in accordance with the received Keep Alive message in step S813.

While managing the link at the application level, if a device control command is received from the multi-device controller 10 in step S815, the ZigBee coordinator 20 generates a ZigBee control message in step S817 and transmits the ZigBee control message to the end device in step S819.

The end device controls the sensory device connected thereto on the basis of the ZigBee control message in step S821, and then notifies the ZigBee coordinator 20 of the response for the control of the sensory device in step S823.

The end device is substantially a small and low-power device, and in many cases, operates with a battery. For this reason, in terms of the lifespan of the battery, if there is no operation in the end device for a predetermined time, a Sleep message is transmitted from the end device to the ZigBee coordinator 20 in step S825, and the end device is put in the sleep mode in step S827.

Next, while the end device, which is put in the sleep mode, is being managed by the device mapmaker 206, if the device control command is inputted from the multi-device controller 10 in step S829, the ZigBee coordinator 20 transmits a Wake Up message to the end device being in the sleep mode in step S831. Then, the end device being in the sleep mode is switched into the normal mode in response to the Wake up message in step S833, and sends a response to switching to the normal mode.

Thereafter, the ZigBee coordinator 20 transmits the ZigBee control message to the end device that is switched to the normal mode in step S835, and the end device controls the sensory device in accordance with the ZigBee control message in step S837.

When the end device does not need to use the sensory device anymore, a Release message is transmitted from the end device to the ZigBee coordinator 20 in step S839. Then, the ZigBee coordinator 20 provides a Disconnection message to the multi-device controller 10 in step S841.

If the multi-device controller 10 sets such that an IR device is fixed in step S843, the ZigBee coordinator 20 transmits a message to fix an IR control code to the end device in step S845, downloads an IR control code from the multi-device controller 10, and transmits the downloaded IR control code to the end device in step S847.

When a short control command is inputted from the multi-device controller 10 in step S849, the ZigBee coordinator 20 transmits a short control message to an end device in step S851. Then, the end device, upon receipt of the short control message, searches for the IR code storage unit 305 to find an IR control code corresponding to the short control message, and generates an IR signal corresponding to the IR control code in step S853, thereby controlling the sensory device in step S855.

While the invention has been shown and described with respect to the particular embodiments, it will be understood by those skilled in the art that various changes and modification may be made without departing from the scope of the invention as defined in the following claims.

What is claimed is:

1. A multi-device controller for controlling a plurality of sensory devices based on sensory effect metadata included in a single media, comprising:
an application control API (Application Programming Interface) for providing a device control command to control the sensory devices on the basis of the sensory effect metadata;
a profile pool for storing IR control codes of the sensory devices as IR profiles;
a profile manager for learning the IR control codes to construct the IR profiles to be stored in the profile pool;
a control manager for acquiring an IR control code of a sensory device to be controlled through the profile manager and providing a control command of the acquired IR control code to the sensory device to be controlled; and
a connection manager for managing the connection of the sensory devices, wherein the connection manager requests the profile manager to learn a new IR code system when there is a new sensory device having the new IR code system, and the profile manager stores an IR profile of the learned IR control code in the profile pool.

2. The multi-device controller of claim 1, in case where the sensory devices are controlled by their corresponding end devices, respectively, further comprising an IR device fixer for fixing the IR control code of the sensory device to be controlled such that a short control message is provided to the sensory device when providing the same control command thereto, wherein the IR control code is downloaded once in the end device.

3. The multi-device controller of claim 2, wherein the control manager releases a connection of the end device when receiving a Release message from the end device.

4. A ZigBee coordinator for controlling a plurality of sensory devices using a control command provided thereto, comprising:
a parser for parsing the control command;
a device determiner for determining a sensory device to be controlled in response to the parsed control command from the parser;
a message manager for generating a control message to be transmitted to an end device having the sensory device connected thereto, wherein the message manager allocates an end point ID to the end device, which requests the binding, when receiving a Binding message from the end device and manages the Join message on the allocated end point ID therein through mapping when receiving a Join message from the end device having the allocated end point ID;
an IR code fixer for instructing the IR control code to be generated from the end device when the end device is fixed; and
a device mapmaker for fixing the IR control code in response to the instruction of the IR code fixer and for mapping an device ID of the end device, a control type and control method of the sensory device connected to the end device on an end point ID of the ZigBee coordinator.

5. The ZigBee coordinator of claim 4, wherein the message manager deletes the Binding message when a Keep Alive message is not received from the end device for a predetermined time, and maintains the connection of the end device to the ZigBee coordinator when the Keep Alive message is cyclically received.

6. The ZigBee coordinator of claim 4, wherein the message manager manages the connection of the end device to the ZigBee coordinator when a Sleep message is received from the end device, and the message manager manages transmits a Wake Up message to the end device, when a control command for controlling a sleep state of the sensory device is received from the multi-device controller.

7. The ZigBee coordinator of claim 4, wherein the message manager deletes the Binding message when receiving a Release message from the end device.

8. The ZigBee coordinator of claim 4, wherein the message manager controls the device determiner to determine the sensory device to be controlled, and confirms the device ID, end point ID, control type and method through the device mapmaker when receiving a device control command to control the sensory device.

9. An end device having a sensory device to be controlled by a control message, comprising:
a parser for parsing the control message provided to the end device;
a control type determiner for determining the control type of the sensory device, wherein the control type includes a ZigBee type and ZigBee-IR type;
an IR code storage unit, if the end device is fixed, for downloading an IR control code of the sensory device to be fixed and storing the IR control code therein;
a command manager for generation a control command depending on the control type determined by the control type determiner;
an internal command generator for generating an internal interface command under the control of the command manager when the control type is the ZigBee type;
an IR code generator for generating an IR control signal under the control of the command manager when the control type is the ZigBee-IR type; and
a control transmitter transmitting the generated internal interface command and IR control signal to the sensory device.

10. The end device of claim 9, wherein the command manager searches the IR code storage unit for an IR control code corresponding to the short control message, and controls the IR code generator to generate an IR control signal corresponding to the IR control code when receiving the short control message.

11. The end device of claim 9, wherein the IR code generator generates an IR control signal corresponding to the IR control code.

12. A system for controlling a plurality of sensory devices based on sensory effect metadata included in a single media, comprising:
a plurality of end devices having the plurality of sensory devices connected thereto, respectively, each end device generating an IR control signal to execute a sensory devices so as to present sensory effects;
a multi-device controller for managing IR control codes as profiles, and issuing a device control command to control the sensory device on the basis of the sensory effect metadata; and
a ZigBee coordinator for parsing the device control command from the multi-device controller, determining the sensory device to be controlled depending on the parsed control command and transmitting a control message corresponding to the parsed control command to the end device having the determined sensory device connected thereto through ZigBee communication.

13. A method for controlling a plurality of sensory devices, comprising:
providing a device control command for representing sensory effect based on sensory effect metadata included in a single media to a multi-device controller;
providing the device control command from the multi-device controller to a ZigBee coordinator;
generating a ZigBee control message corresponding to the device control command to provide to an end device; and
controlling the sensory device connected to the end device using a control signal corresponding to the ZigBee control message.

14. The method of claim 13, wherein said providing the device control command from the multi-device controller to the ZigBee coordinator comprises:
confirming whether or not there is a new sensory device connected to the ZigBee coordinator;
acquiring an IR control code corresponding to the device control command if there is the new sensory device; and
generating a control command corresponding to the acquired IR control code to provide the control command to the ZigBee coordinator.

15. The method of claim 13, wherein said generating the ZigBee control message corresponding to the device control command comprises:
determining a message received from the end device;
allocating an end point ID from the ZigBee coordinator to the end device, which requests the binding if it is determined that a Binding message is received from the end device; and
mapping a Join message on the end point ID therein if it is determined that the Join message is received from the end device having the allocated end point ID to the ZigBee coordinator, wherein the Join message includes the allocated end point ID, a device ID, a control type and method.

16. The method of claim 15, wherein said determining the message received from the end device comprises deleting the Binding message if it is determined that a Keep Alive message is not received from the end device for a predetermined time to the ZigBee coordinator, and maintaining the connection of the end device to the ZigBee coordinator if it is determined that the Keep Alive message is cyclically received.

17. The method of claim 15, wherein said determining the message received from the end device comprises maintaining the connection of the end device to the ZigBee coordinator if it is determined that a Sleep message is received from the end device, and transmitting a Wake Up message to the end device if it is determined that a control command for controlling a sleep state of the sensory device is received.

18. The method of claim 15, wherein said determining the message received from the end device comprises deleting the Binding message if it is determined that a Release message from the end device is received.

19. The method of claim 13, wherein said controlling the sensory device connected to the end device comprises:
parsing the ZigBee control message from the ZigBee coordinator to determine a control type of the sensory device to be controlled, wherein the control type includes a ZigBee type and ZigBee-IR type;
generating the control signal for the sensory device to be controlled depending on the determined control type;
providing the control signal to the end device having the sensory device connected thereto; an internal interface command is generated when the control type is the ZigBee type; and
an IR control signal is generated when the control type is the ZigBee-IR type.

20. The method of claim 19, wherein said parsing the ZigBee control message includes determining whether or not the ZigBee control message is a short control message, searching for an IR control code corresponding to the short control message when the ZigBee control message is a short control message, and generating an IR control signal corresponding to the IR control code.
